(19) United States
(12) Patent Application Publication
(10) Pub. No.: US 2018/0308119 A1
(43) Pub. Date: Oct. 25, 2018

(54) System and method of loyalty reward network program

(71) Applicants: Eugene N Bardakjy, Davie, FL (US); William Frank Fennell, IV, Davie, FL (US)

(72) Inventors: Eugene N Bardakjy, Davie, FL (US); William Frank Fennell, IV, Davie, FL (US)

(73) Assignee: Klosebuy Inc., Davie, FL (US)

(21) Appl. No.: 15/493,331

(22) Filed: Apr. 21, 2017

(51) Int. Cl. G06Q 30/02

(52) U.S. Cl. CPC G06Q 30/0233; G06Q 30/0603; G06Q 30/0227

(57) ABSTRACT

Businesses purchase a finite amount of points within a digital marketing and loyalty web platform and can assign any amount of points to be delivered to its customers for any promotion or advertisement, changing them at any time. Customers or members within the platform may either choose to redeem those points back at the business for rewards that can be changed at any time and for any value by the business, or customers may elect to combine their points and redeem them for an item within the online catalog of the platform. This allows the businesses to change at will both the promotions and rewards, value of the points delivered and to be spent by the customer, as well as allowing customers to choose whether they spend their points back at the business and/or combine their points to redeem in the catalog.

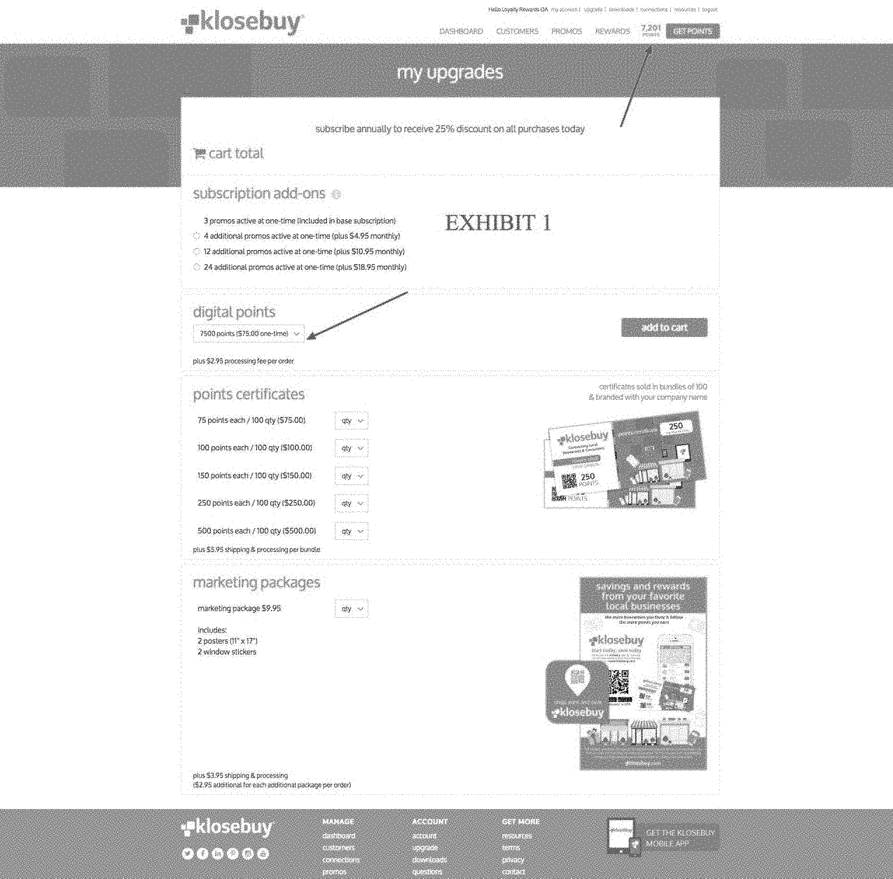

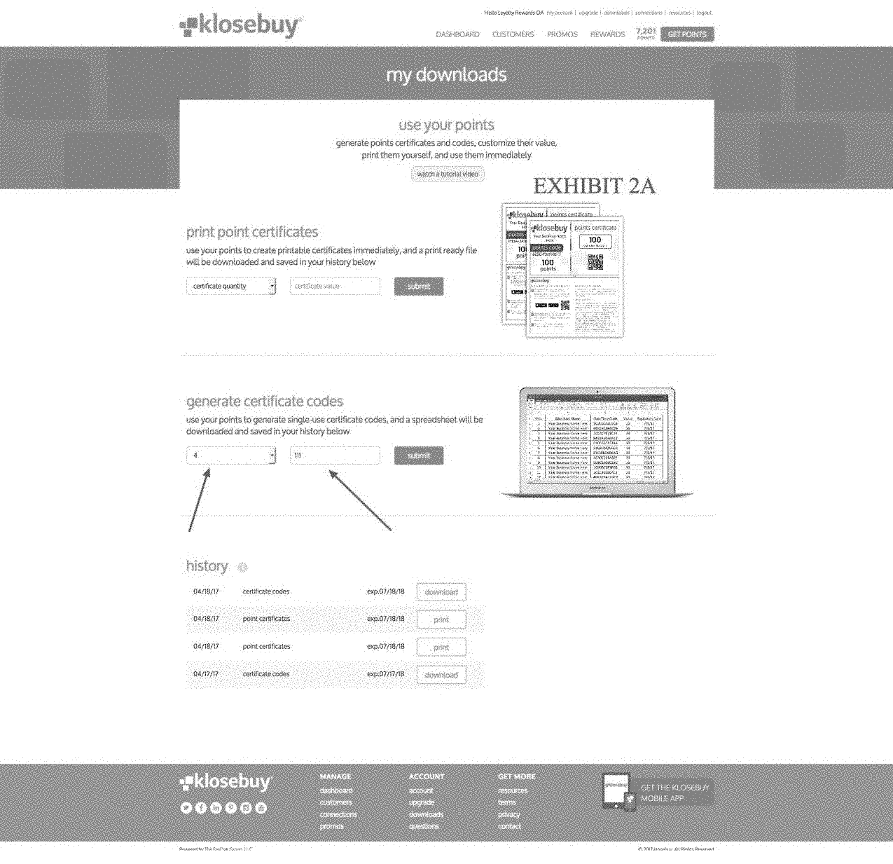

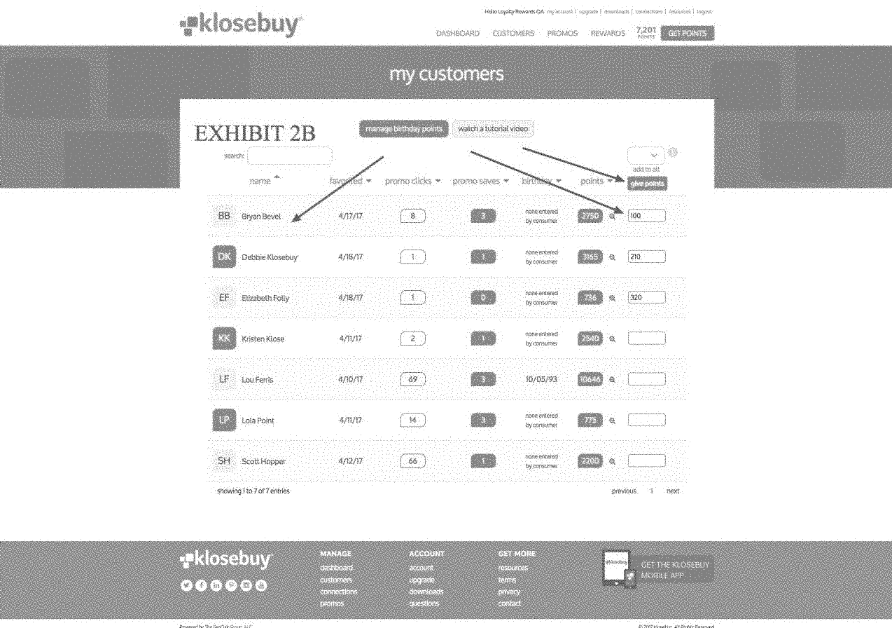

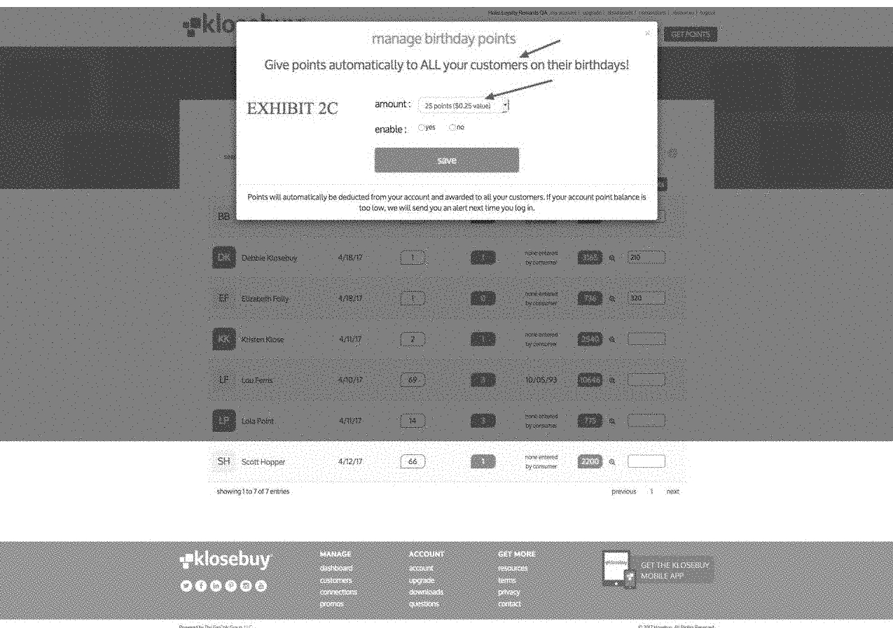

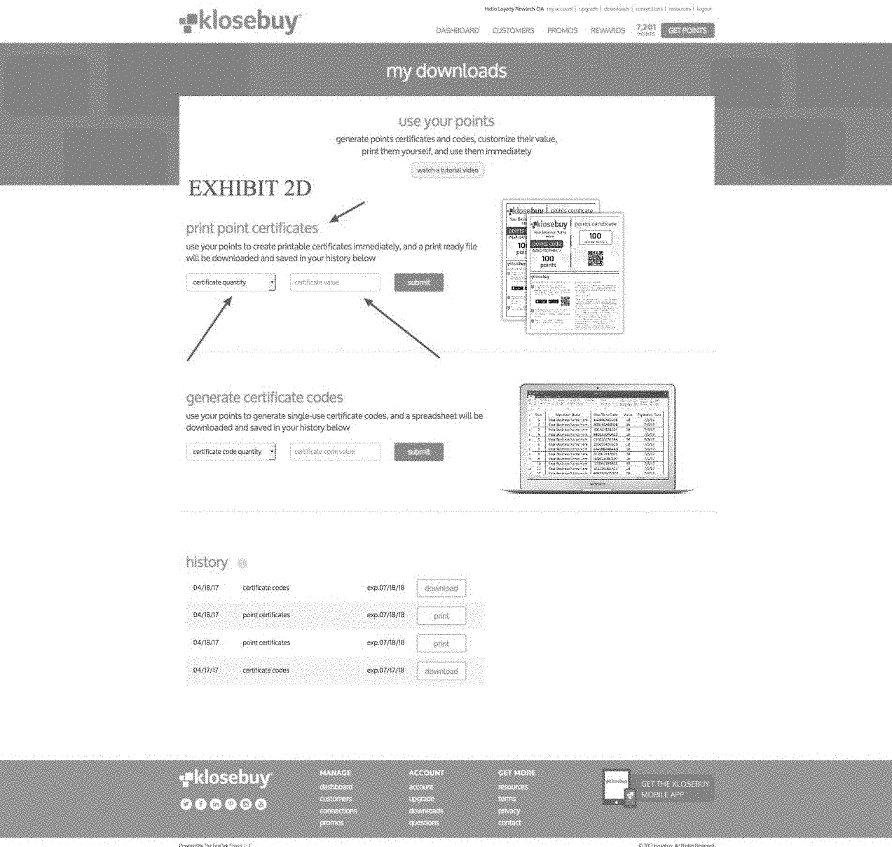

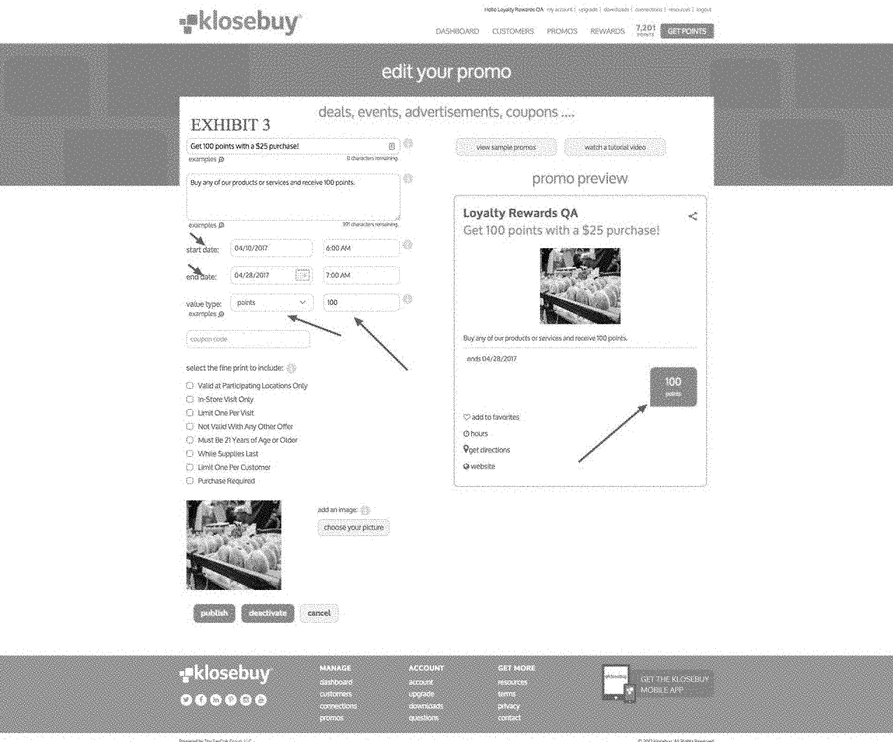

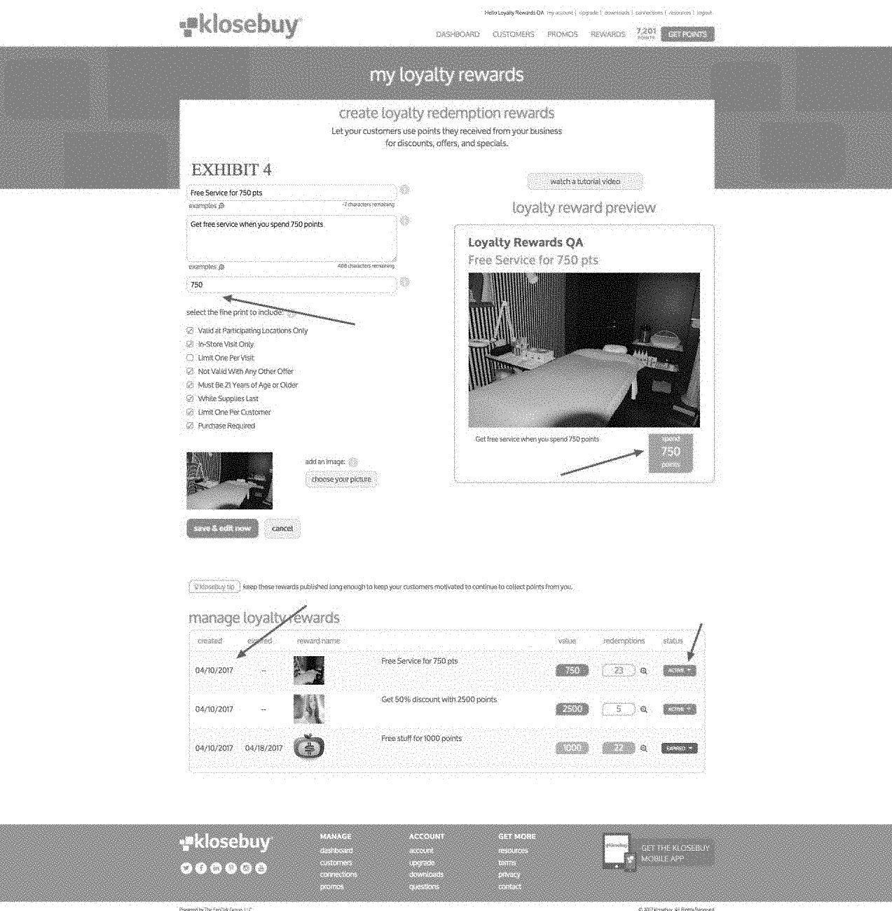

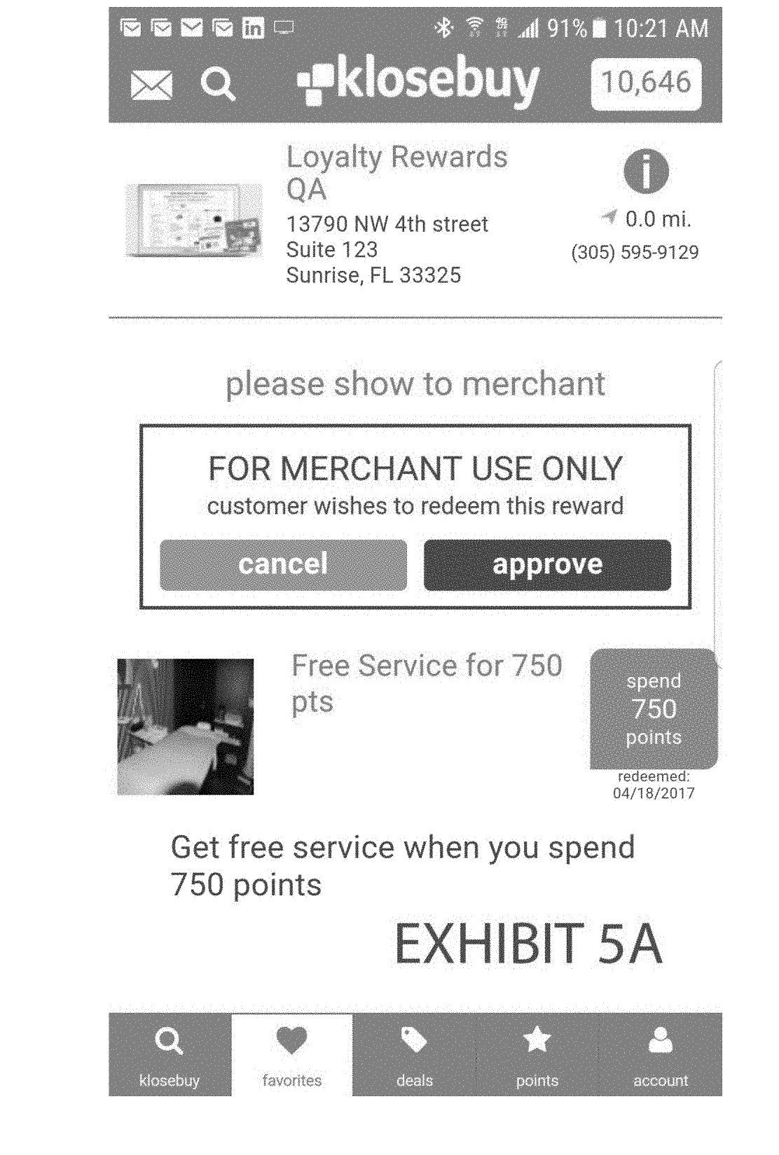

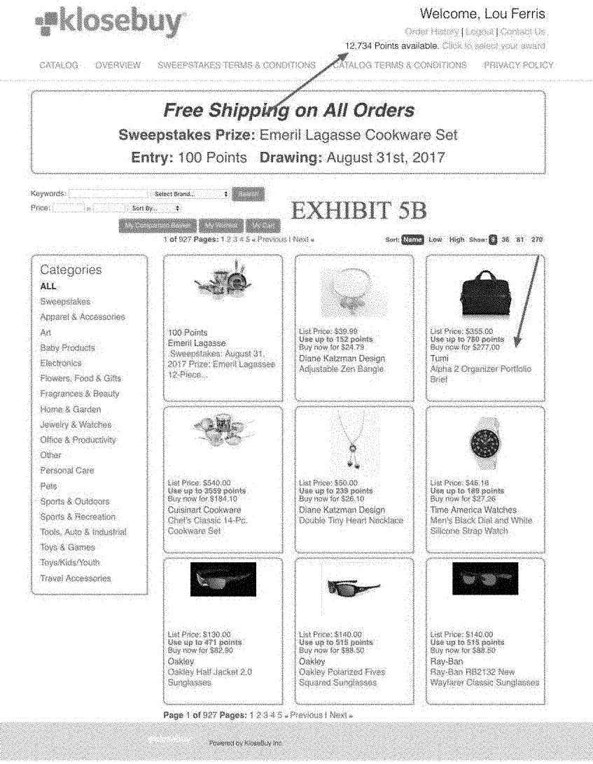

### OVERVIEW OF THE BUSINESS PROCESS INVENTION

1. The business process invention relates to giving merchants, in a closed loop network, the ability to purchase a finite number of loyalty points and deliver them to their customers in a variety of values, in a variety of ways, and for a variety of reasons.

2. The business process invention also includes giving customers the ability, when spending their points at any time, to either pool their points and spend them in an online catalog of products, and/or redeem the points received from a single merchant for rewards delivered by that merchant.

3. This business process invention further allows the business to elect and change continually how many points are delivered to its customers by promotion or advertisement within the network, as well as elect and change continually how many points their customers can redeem for a reward offered by their business.

### BACKGROUND OF THE INVENTION

4. Loyalty points have been used in a variety of ways with businesses to increase customer loyalty through repeat visits, or to influence customer behavior. Formerly, traditional loyalty points systems calculate the award of points based upon a set formula, such as amount spent (credit card points), or visits to a location (digital punch card).

5. Traditionally, the redemption options for points for customers within a closed looped system only included one way for the consumer to redeem their points. The consumer either redeems points back at the merchant's place of business for an advertised reward (digital punch card), or the consumer collects their points (credit card points) to redeem for a distinct reward delivered within the network. These traditional loyalty programs do not allow the consumer to have the flexibility on the fly and at any time to spend their points received at a business for that merchant's rewards, or pool an amount of points received from a variety of businesses, to spend them for products in an online catalog from the network.

6. Traditionally, these loyalty systems also do not allow merchants to buy incremental points from the program, then have the flexibility to deliver to it's customers points in a variety of amounts and for an unlimited variety of reasons as outlined in its promotion or advertisement.

1. The business process invention allows merchants to buy a finite number of loyalty points to then distribute piecemeal and award to customers. (Exhibit 1)

2. The business process invention allows a merchant to deliver the points to their customers in a variety of ways and for any value:
a. Businesses can download one-time use codes that they create with specific values; (Exhibit 2a)
b. Businesses can deliver the digital points directly to customers within the platform for any value; (Exhibit 2b)
c. Businesses can automatically award points for customer birthdays; (Exhibit 2c)
d. Businesses can print one-time use certificates for any value that customers can input into the platform to collect their points. (Exhibit 2d)

3. The business process invention allows a merchant to create and change at any time the promotion, advertisement, or customer action required to collect points, as well as change at any time the number of points to be awarded to the consumer. (Exhibit 3)

4. The business process invention allows a merchant to create and change at any time the loyalty reward offer and points value that allows customers to spend their points awarded by the merchant for the loyalty reward offered by the merchant. (Exhibit 4)

5. The business process invention allows consumers within the network, when electing to spend any of their points, the dual option to spend their points:
a. either back at the merchant who awarded the points; (Exhibit 5a) or
b. pool their points to use in a products catalog offered by the network. (Exhibit 5b)
